(19) United States
(12) Patent Application Publication
(10) Pub. No.: US 2016/0038957 A1
(43) Pub. Date: Feb. 11, 2016

(54) REMOTE BULK FEED SYSTEM FOR A DISPENSING SYSTEM AND METHOD OF SUPPLYING VISCOUS MATERIAL TO A DISPENSING SYSTEM

(71) Applicant: Illinois Tool Works Inc., Glenview, IL (US)

(72) Inventors: Thomas C. Prentice, Westford, MA (US); Patsy A. Mattero, Smithfield, RI (US); Thomas E. Robinson, Walpole, MA (US); Dennis G. Doyle, Shrewsbury, MA (US)

(21) Appl. No.: 14/452,627

(22) Filed: Aug. 6, 2014

(51) Int. Cl. B05B 9/04; B05B 12/08; B05D 1/02

(52) U.S. Cl. CPC B05B 9/0403; B05D 1/02; B05B 12/081

(57) ABSTRACT

A dispenser includes a frame, a substrate support assembly, and a gantry system to move a dispensing pump in x-axis, y-axis, and z-axis directions. The dispensing pump includes a local supply reservoir, a dispensing nozzle, a first line to provide fluid communication between the local supply reservoir and the dispensing nozzle. The dispenser further includes a remote bulk feed system coupled to the local supply reservoir of the dispensing pump. The bulk feed system includes a first remote supply container configured to contain viscous material, a second line to provide fluid communication between the remote bulk feed system and the local supply reservoir, and a first valve disposed in the second line and operable to deliver viscous material to and to cut off viscous material from the remote supply container.

### BACKGROUND OF THE DISCLOSURE

1. Field of the Invention

The invention relates generally to methods and apparatus for dispensing a viscous material, such as solder paste, on a substrate, such as a printed circuit board, and more particularly to a remote bulk feed system for a dispensing system.

2. Discussion of Related Art

There are several types of prior art dispensing systems used for dispensing metered amounts of liquid or paste for a variety of applications. One such application is the assembly of integrated circuit chips and other electronic components onto circuit board substrates. In this application, automated dispensing systems are used for dispensing dots of liquid epoxy or solder paste onto the circuit board substrates. The liquid epoxy and solder paste are used to mechanically and electrically connect components to a circuit board substrate. In such dispensing systems, it is typical that an alignment vision system is used to locate certain features on a substrate for the purpose of aligning the dispensing operations relative to certain features on the substrate. Exemplary dispensing systems are manufactured and distributed by Speedline Technologies, Inc. of Franklin, Mass.

A typical dispensing system employs a cartridge that contains the material to be dispensed on the substrate. The cartridge is typically relatively small in that it is capable of holding thirty cubic centimeters (30 cc) of material. One advantage of using smaller cartridges is that accurate pressure control can be achieved to produce more consistent dispensing results. Remote bulk feed systems that are not carried on the dispensing gantry in the dispensing area are known, and suffer from relatively instable pressure control due to the long fluid path that experiences motion during use. Stabilizing the pressure control is a challenge facing such remote bulk feed systems.

### SUMMARY OF THE DISCLOSURE

One aspect of the disclosure is directed to a dispenser for dispensing viscous material on a substrate. In one embodiment, the dispenser comprises a frame, a substrate support assembly coupled to the frame and configured to support the substrate in a dispense position to dispense material on the substrate, and a gantry system coupled to the frame. The gantry system is configured to move a dispensing pump in x-axis, y-axis, and z-axis directions. The dispenser further comprises a dispensing pump coupled to the gantry system. The dispensing pump includes a local supply reservoir, a dispensing nozzle, a first line to provide fluid communication between the local supply reservoir and the dispensing nozzle. The dispenser further comprises a remote bulk feed system coupled to the local supply reservoir of the dispensing pump. The bulk feed system includes a first remote supply container configured to contain viscous material, a second line to provide fluid communication between the remote bulk feed system and the local supply reservoir, and a first valve disposed in the second line and operable to deliver viscous material to and to cut off viscous material from the remote supply container.

Embodiments of the bulk feed system of the dispenser further may include a second valve disposed in the first line and operable to deliver viscous material to and to cut off viscous material from the dispensing nozzle. The bulk feed system further may include a second remote supply container, a third line to provide fluid communication between the second remote supply container and the second line, and a third valve disposed in the third line and operable to deliver viscous material to and to cut off viscous material from the second line. The bulk feed system further may include a fourth valve disposed in the fourth line that intersects the second line between the remote supply container and the first valve, the fourth valve being configured to purge air. The bulk feed system further may include a bubble sensor disposed in the second line between the first valve and the local supply reservoir. The bubble sensor may be associated with a filter. The bulk feed system further may include a low level sensor to detect a level of viscous material within the remote supply container below a predetermined amount. The local supply reservoir of the dispensing pump may include a low level sensor and a high level sensor. The dispensing pump further may include a second local supply reservoir and a third line to provide fluid communication between the second local supply reservoir and the dispensing nozzle.

Another aspect of the disclosure is directed to a method of dispensing viscous material onto a substrate with a dispenser. In one embodiment, the method comprises: selectively dispensing viscous material from a dispensing nozzle of a dispensing head of the dispenser; and controlling a flow of viscous material from a remote bulk feed system to a local supply reservoir of the dispensing head configured to contain viscous material. The bulk feed system includes a remote supply container configured to contain viscous material and a line to provide fluid communication between the bulk feed system and the local supply reservoir.

Embodiments of the method further may include sensing gas bubbles in the line after the first valve with a bubble sensor. The method further may include purging the line when gas bubbles are sensed in the line by the bubble sensor. The method further may include sensing a level of viscous material in the remote supply container of the bulk feed system below a predetermined amount with a low level sensor coupled to the remote supply container. The method further may include sensing a level of viscous material in the local supply reservoir below a predetermined amount with a lower level sensor coupled to the local supply reservoir. The method further may include sensing a level of viscous material in the local supply reservoir above a predetermined amount with a high level sensor coupled to the local supply reservoir. The method further may include pressurizing the viscous material within the remote supply container of the bulk feed system. Controlling the flow of viscous material may include operating a first valve in the line to deliver viscous material to and to cut off viscous material from the local supply reservoir, with the flow of viscous material from the bulk feed system to the local supply reservoir of the dispensing head being achieved when the dispensing head is not being used. The remote bulk feed system further may include a second remote supply container. The method further may include controlling a flow of viscous material from the second remote supply container to the local supply reservoir with a second valve disposed between the second remote supply container and the local supply reservoir. The first valve and the second valve may be pinch valves. The method further may include automatically purging the second line after switching the first remote supply container with the second remote supply container.

### BRIEF DESCRIPTION OF THE DRAWINGS

For a better understanding of the disclosure, reference is made to the figures which are incorporated herein by reference and in which:

FIG. 1 is a schematic view of a dispenser of an embodiment of the disclosure;

FIG. 2 is a front perspective view of the dispenser shown in FIG. 1;

FIG. 3 is a side perspective view thereof;

FIG. 4 is an enlarged front perspective view of an remote bulk feed system of an embodiment of the present disclosure;

FIG. 5 is another enlarged front perspective view of the remote bulk feed system with packaging removed;

FIG. 6 is a schematic view of a dispensing head of the dispenser;

FIG. 7 is a schematic view of the remote bulk feed system and the dispensing head of the dispenser;

FIG. 8 is a schematic view of a remote bulk feed system and a dispensing head of another embodiment;

FIG. 9 is a schematic view of a remote bulk feed system and a dispensing head of another embodiment; and

FIG. 10 is a schematic view of a remote bulk feed system and a dispensing head of another embodiment.

### DETAILED DESCRIPTION OF THE PREFERRED EMBODIMENTS

For the purposes of illustration only, and not to limit the generality, the disclosure will now be described in detail with reference to the accompanying figures. This disclosure is not limited in its application to the details of construction and the arrangement of components set forth in the following description or illustrated in the drawings. The disclosure is capable of other embodiments and of being practiced or being carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

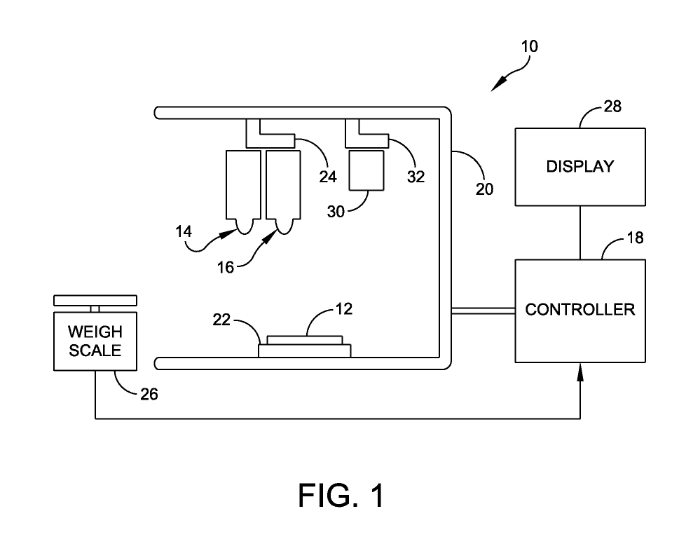

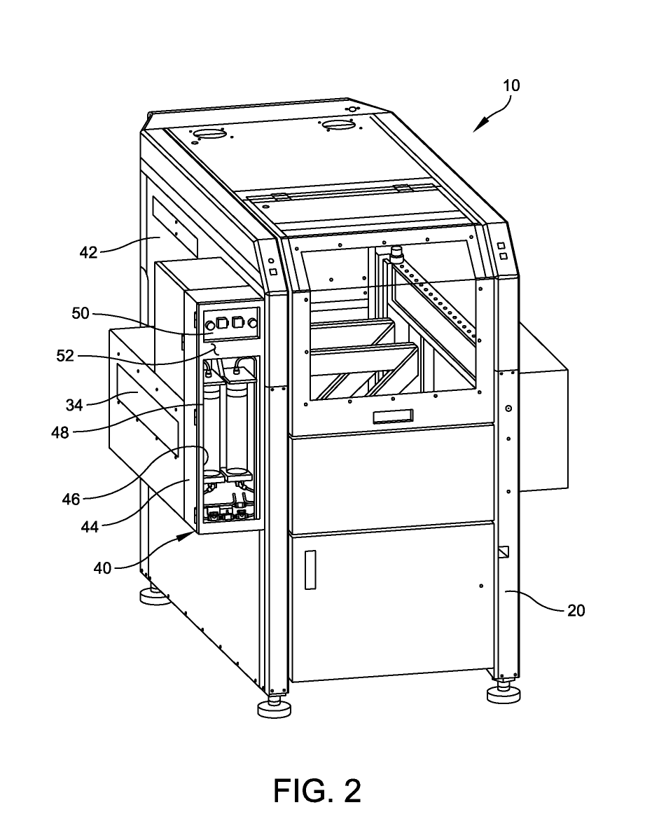

FIG. 1 schematically illustrates a dispenser, generally indicated at 10, according to one embodiment of the present disclosure. FIG. 2 illustrates a physical embodiment of the same dispenser 10. The dispenser 10 is used to dispense a viscous material (e.g., an adhesive, encapsulent, epoxy, solder paste, underfill material, etc.) or a semi-viscous material (e.g., soldering flux, etc.) onto an electronic substrate 12, such as a printed circuit board, semiconductor wafer, or other electronic substrate. In other embodiments, the dispenser 10 can be used to dispense less-viscous materials, such as conductive inks or the like. The dispenser 10 may alternatively be used in other applications, such as for applying automotive gasketing material or in certain medical applications. It should be understood that references to viscous, semi-viscous, or less-viscous materials, as used herein, are exemplary and intended to be non-limiting. The dispenser 10 includes first and second dispensing pumps or heads, generally indicated at 14 and 16, respectively, and a controller 18 to control the operation of the dispenser. Although two dispensing pumps are shown, it should be understood that one or more dispensing pumps may be provided.

The dispenser 10 may also include a frame 20 having a base or support 22 for supporting the substrate 12, a dispensing pump gantry 24 movably coupled to the frame 20 for supporting and moving the dispensing pumps 14, 16, and a weight measurement device or weigh scale 26 for weighing dispensed quantities of the viscous material, for example, as part of a calibration procedure, and providing weight data to the controller 18. A conveyor or transport system 34 or other transfer mechanism, such as a walking beam, may be used in the dispenser 10 to control loading and unloading of substrates to and from the dispenser. The gantry 24 can be moved using motors under the control of the controller 18 to position the dispensing pumps 14, 16 at predetermined locations over the substrate. The dispenser 10 may include a display unit 28 connected to the controller 18 for displaying various information to an operator. There may be an optional second controller for controlling the dispensing pumps.

Prior to performing a dispensing operation, as described above, the substrate, e.g., printed circuit board, must be aligned or otherwise in registration with a dispenser of the dispensing system. The dispenser further includes a vision system 30, which is coupled to a vision system gantry 32 movably coupled to the frame 20 for supporting and moving the vision system. Although shown separately from the dispensing pump gantry 24, the vision system gantry 32 may utilize the same gantry system as the dispensing pumps 14, 16. As described, the vision system 30 is employed to verify the location of landmarks, known as fiducials or other features and components, on the substrate. Once located, the controller can be programmed to manipulate the movement of one or both of the dispensing pumps 14, 16 to dispense material on the electronic substrate.

Systems and methods of the present disclosure are directed to the operation of the dispensing pumps 14, 16. The description of the systems and methods provided herein reference exemplary electronic substrates (e.g., printed circuit boards), which are supported on the support 22 of the dispenser 10. In one embodiment, the dispense operation is controlled by the controller 18, which may include a computer system configured to control material dispensers. In another embodiment, the controller 18 may be manipulated by an operator. As described above, the dispenser 10 includes the transport system 34 provided to shuttle substrates into and out of the dispenser.

In one embodiment, the dispenser further includes a remote bulk feed system that is configured to create stable material pressure at the dispensing pump or pumps of the dispenser when replenishing viscous material within the dispenser with the remote bulk feed system. With prior remote bulk feed systems, material is pushed through a long tube to get to the point of use at a cartridge of the dispensing pump. As a result of the long path and the fact that the tube experiences motion during use, the material pressure at the dispensing pump is less stable. In embodiments of the present disclosure, valves, such as pinch valves, are used to control material flow and to control which pressure system actually controls the pressure at the pump. Valves are provided at several locations to shut off the supply of material from the reservoir to the pump. The valves also shut off the supply of material to the reservoir. The remote bulk feed system prevents the daily intervention of the process to replenish viscous material, yet reap the benefits of the tight pressure control that is normally associated with a small cartridge material feed system. A small local cartridge material feed system enables very tight pressure control at the dispensing pump, which produces more consistent dispensing results. In one embodiment, the local supply cartridge holds about 30 cc of material. The supply cartridge is largely meant for one-time use and last about an eight hour production shift. When the dispensing pump is dispensing, the pressure will come from above the local supply of material via a tightly controlled pressure regulator. When the dispensing pump is not being used, the valve will block off the path from the local supply cartridge to the dispensing pump, and the supply cartridge will be refilled from the remote bulk feed system by opening the valves between the remote feed system and the local supply cartridge.

Additional features of the remote bulk feed system address a prevention of air bubbles in the viscous material, as well as allow for the complete use of the material. Specifically, when the supply cartridge is indicated as being consumed, the supply cartridge is not fully consumed in that there is always some remaining viscous material left over at the bottom of the cartridge since the sensor cannot be set at the absolute zero amount. Thus, there is always an unknown amount of viscous material below a sensor trigger position. Since the viscous material is expensive, it is desirable to automatically or manually salvage this material. The approach will be controlled by a manual button or by an automated process. The valves of the remote bulk feed system open and close a path between a supply container and the supply cartridge. This will push the remaining material from the mostly consumed supply cartridge into the new supply cartridge so that it is not wasted.

When a new supply cartridge is introduced, there is an air void introduced where the new supply cartridge is screwed into the fitting. If the air void is allowed to travel to the dispensing pump, then defective product could get produced since an accurate amount of material may not be dispensed. The remote bulk feed system of embodiments of the disclosure automatically or manually remove the air bubble while wasting only a minimal amount of viscous material. The purging of the air bubble(s) can be controlled by a manual button or by an automated process. Valves are used to block off the path to the pump and to open a path to a purge container. This will allow only a minimal amount of viscous material to be purged prior to opening up the path to the dispensing pump.

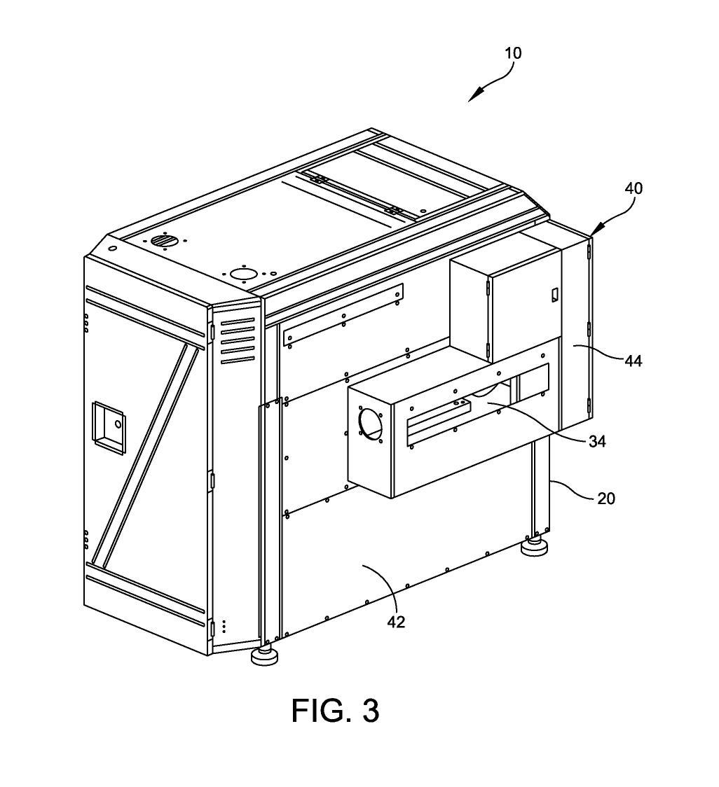

As shown in FIGS. 2 and 3, the dispenser 10 further includes a remote bulk feed system, generally indicated at 40, which is mounted on one side 42 of the frame 20 of the dispenser. In the shown embodiment, the remote bulk feed system 40 includes a housing 44 configured to support the components of the remote bulk feed system. The housing 44 is mounted on the side 42 of the frame 20 of the dispenser adjacent to the transport system 34, and includes a chamber 46 that supports bulk feed material supplied in the chamber. In one embodiment, the housing 44 includes a removable panel or door 48 to allow access into the chamber 46 of the housing 44. The housing 44 further includes a control panel 50 provided on a front surface 52 of the housing above the removable panel or door 48. The control panel 52 provides operational control and status information for the remote bulk feed system 40.

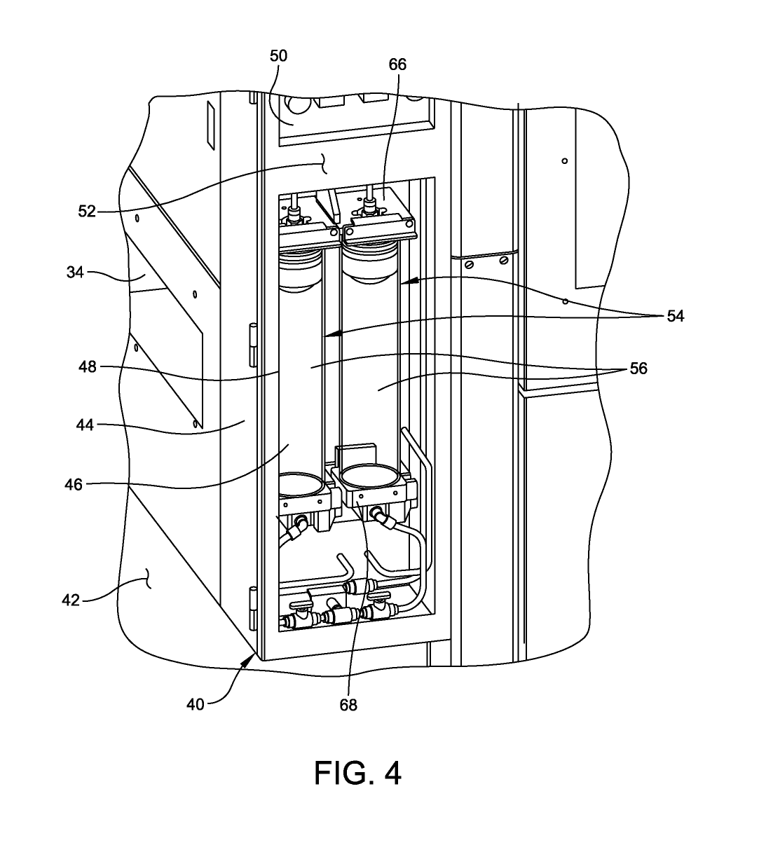

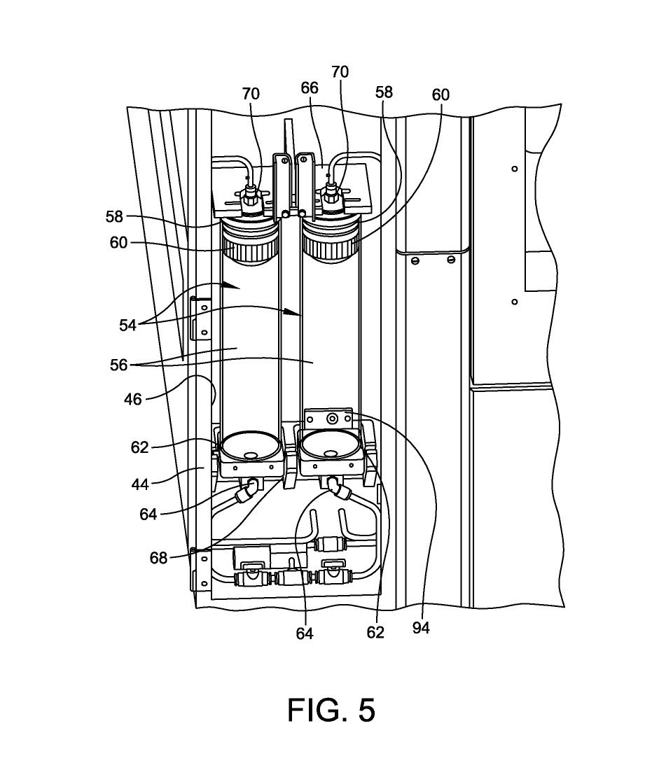

Referring to FIGS. 4 and 5, in one embodiment, the chamber 46 of the housing 44 is sized and configured to support two relatively large supply containers, each generally indicated at 54. As shown, each supply container 54 includes a cylindrical body 56 having an open top 58 that is closed by a cylindrical plug 60 and a substantially closed bottom 62 having an outlet 64. An upper bracket assembly 66 is provided to secure upper ends 58 of the supply containers 54 and a complementary lower bracket assembly 68 is provided to secure lower ends 62 of the supply containers. The upper bracket assembly 66 includes two gas inlets, each indicated at 70, for introducing pressurized gas into the supply containers 54 through the cylindrical plugs 60 from a remote gas source. Pressurized gas (air or nitrogen) is used to force the viscous material out of the supply containers 54 through their respective outlets 64. As will be described in greater detail below, the supply containers 54 are in fluid communication with a supply cartridge of the dispensing head 14 or 16 when one dispensing head is provided, or for dispensers having two dispensing heads, in fluid communication with respective supply cartridges of the dispensing heads 14, 16. In one embodiment, each supply containers 54 is capable of holding 1000 cc of material; however, the supply cartridges may be designed to hold any amount of material.

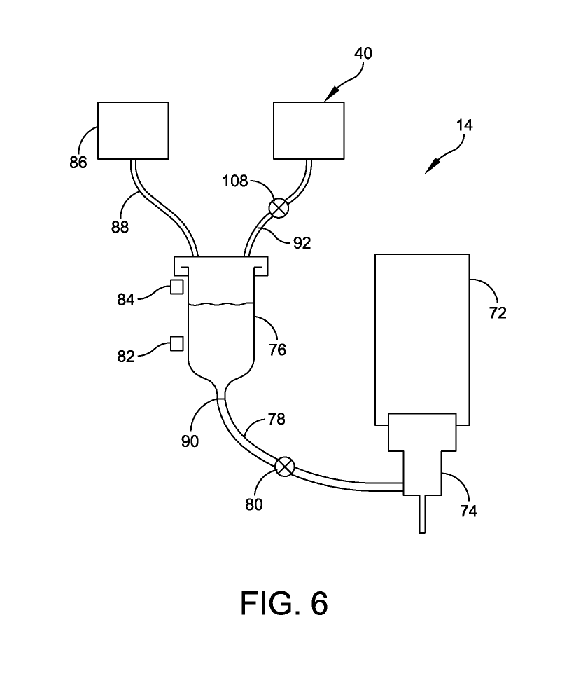

In particular, with reference to FIG. 6, the dispensing head, e.g., dispensing head 14, includes a housing 72 and a dispensing nozzle 74 provided at a lower end of the housing. In one embodiment, the housing 72 of the dispensing head 14 supports a rotating auger having a helical groove to force material out of a nozzle and onto a substrate. One such system is disclosed in U.S. Pat. No. 5,819,983, entitled LIQUID DISPENSING SYSTEM WITH SEALING AUGERING SCREW AND METHOD FOR DISPENSING, which is owned by Speedline Technologies, Inc. of Franklin, Mass. In a typical operation employing an auger-type dispenser, the dispensing head is lowered towards the surface of the substrate prior to dispensing a dot or a line of material onto the substrate and raised after dispensing the dot or line of material. Using this type of dispenser, small, precise quantities of material may be placed with great accuracy. The time required to lower and raise the dispensing unit in a direction normal to the substrate, typically known as a z-axis movement, can contribute to the time required to perform dispensing operations. Specifically, with auger-type dispensers, prior to dispensing the dot or line of material, the dispensing unit is lowered so that the material touches or “wets” the substrate.

It is also known in the field of automated dispensers to use “jetting” to launch dots of viscous material toward the substrate. In another embodiment incorporating such a jetting system, the housing 72 of the dispensing head 14 supports a “jetter” to eject or launch a minute, discrete quantity of viscous material from the dispensing nozzle 74 with sufficient inertia to enable the material to separate from the nozzle prior to contacting the substrate. As discussed above, with the auger-type application or other prior, non-jetting systems, it is necessary to wet the substrate with the dot of material prior to releasing the dot from the nozzle. With jetting, the dots may be deposited on the substrate without wetting as a pattern of discrete dots, or alternatively the dots may be placed sufficiently close to each other to cause them to coalesce into more or less a continuous pattern.

Other types of dispensing heads 14 are further contemplated. For example, an inkjet dispensing head or system may be employed. It should be understood that the remote bulk supply system of the present disclosure may be used on any type of dispensing head.

The dispensing head 14 further includes a supply cartridge 76 to supply viscous material to the housing 72 of the dispensing head. As shown schematically in FIG. 6, the supply cartridge 76 is in fluid communication with the dispensing nozzle 74 of the dispensing head 14 by a line or tube 78. A valve 80 is disposed in the line 78 to control the feed of viscous material to the dispensing nozzle 74 of the dispensing head 14. In one embodiment, the valve 80 is a pinch valve, which forces the wall of the line 78 together to create a seal to selectively open and close the line. Pinch valves are particularly suited for uses involving relatively viscous materials. As shown, the supply cartridge 76 includes a low level sensor 82 to detect a level of viscous material within the supply cartridge below a predetermined amount. The supply cartridge 76 also includes a high level sensor 84 to detect a level of viscous material within the supply cartridge above a predetermined amount. In a certain embodiment, the supply cartridge 76 is in fluid communication with a source of pressurized gas 86 by a line 88. Pressurized gas (air or nitrogen) is used as the source of pressurized gas 86 to force the viscous material out of the supply cartridge 76 through an outlet 90 of the supply cartridge, which communicates with the line 88. In one embodiment, the low level sensor 82 and the high level sensor 84 generate signals to the controller 18 to control a level of viscous material within the supply cartridge 76.

Viscous material is supplied to the supply cartridge 76 by the remote bulk feed system 40 by a line 92 in fluid communication between the supply cartridge and the remote bulk feed system. The arrangement is such that when the low level sensor 82 of the supply cartridge 76 is triggered, the controller 18 controls the remote bulk feed system 40 to deliver viscous material to the supply cartridge. Delivery of viscous material continues until the high level sensor 84 of the supply cartridge 76 is triggered, when the controller 18 shuts off delivery of viscous material from the remote bulk feed system 40 to the supply cartridge. In another embodiment, a processor or controller associated with the remote bulk feed system 40 may be provided in addition to or in place of controller 18 to control the filling of the supply cartridge 76 with the remote bulk supply system 40.

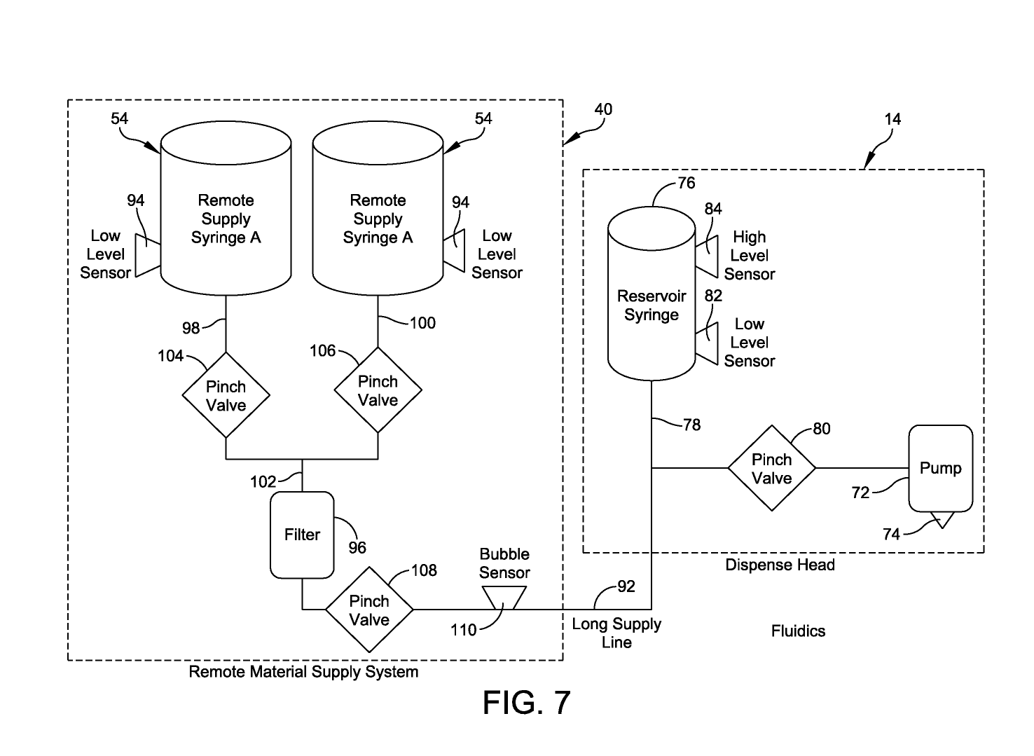

Referring to FIG. 7, the operation of the remote bulk feed system 40 with respect to the dispensing head 14 including the supply cartridge 76 is shown and described. As shown, the two supply containers 54 of the remote bulk feed system 40 contain viscous material, such as solder paste. Each supply container 54 has a low level sensor 94 to indicate when the supply container is at or near an empty condition. In one embodiment, the low level sensor 94 generates a signal to the controller 18 or to a dedicated processor or controller associated with the remote bulk feed system 40. The supply containers 54 are in fluid communication with a filter 96 by lines 98, 100, respectively, which are joined to form line 102 before entering the filter. A valve 104, such as a pinch valve, is disposed in line 98 to control the flow of viscous material from the supply container 54 to the filter 96. Similarly, another valve 106, such as a pinch valve, is disposed in line 100 to control the flow of viscous material from the other supply container 54 to the filter 96. The filter 96 is designed to remove larger particles from the viscous material being supplied to the supply cartridge 76. In some embodiments, the filter may not be required or desirable.

Once the viscous material passes through the filter 96, another valve 108, such as a pinch valve, is provided in line 92 to control the amount of viscous material delivered to the supply cartridge 76. As mentioned above, in a preferred embodiment, the operation of the remote bulk feed system 40 is controlled by the controller 18. In another embodiment, the operation of the remote bulk feed system 40 can be controlled by a processor or controller associated with the bulk feed system. As mentioned above, when a used supply cartridge is replaced by a new supply cartridge, air is introduced into the system where the new supply cartridge is screwed into its fitting. If air is allowed to travel to the dispensing pump 14, then defective product could get produced since an accurate amount of material may not be dispensed. To address this issue, the line 92 between the valve 108 and the supply cartridge 76 may include a bubble sensor 110 to detect the presence of air within the line so that the remote bulk feed system 40 of embodiments of the disclosure automatically or manually remove the air bubble while wasting only a minimal amount of viscous material.

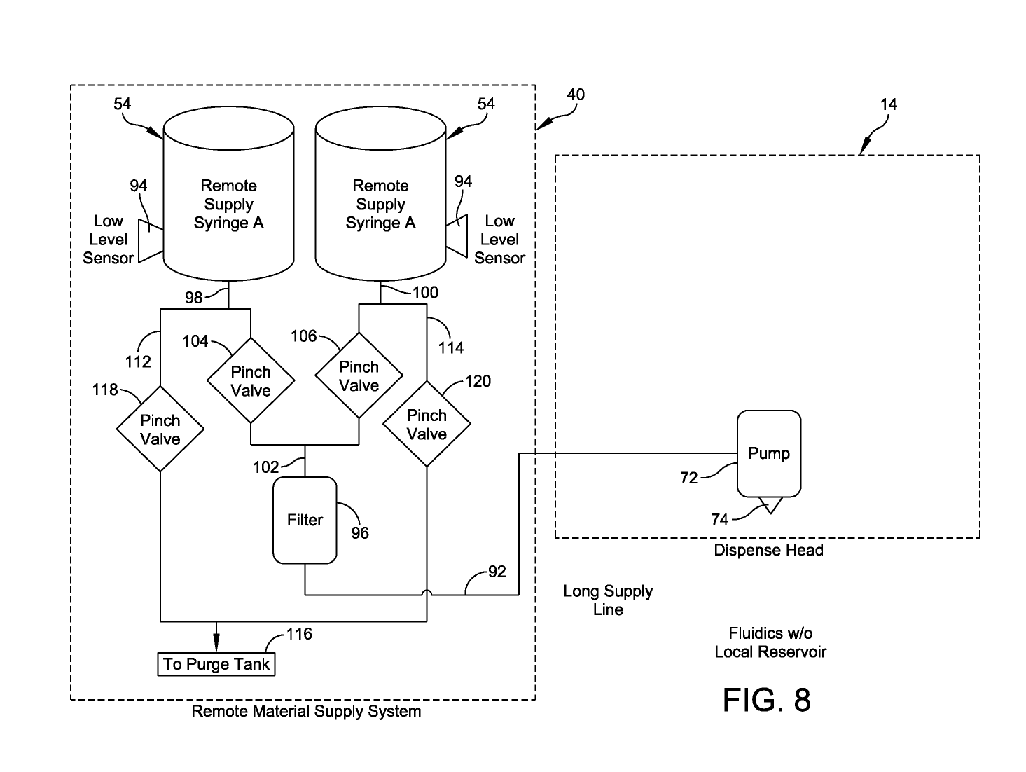

As mentioned above, and with reference to FIGS. 8-10, the remote bulk feed system 40 can be configured to purge air bubble(s) contained within the supply containers 54. As shown in FIG. 8, the two supply containers 54 of the remote bulk feed system 40 contain viscous material, such as solder paste. Each supply container 54 has a low level sensor 94 to indicate when the supply container is at or near an empty condition. In one embodiment, the low level sensor 94 generates a signal to the controller 18 or to a dedicated processor or controller associated with the remote bulk feed system 40. The supply containers 54 are in fluid communication with the filter 96 by lines 98, 100, respectively, which are joined to form line 102 before entering the filter. Valves 104, 106 are provided to control the flow of viscous material from the supply containers 54 to the filter 96. Once the viscous material passes through the filter 96, the viscous material is delivered to the supply cartridge 76. To address the issue of removing air from the line 92, lines 112, 114 are provided that branch from respective lines 98, 100. These lines 112, 114 lead to a purge tank 116. Valves 118, 120 are provided in respective lines 112, 114. The arrangement is such that by closing valves 104, 106, and opening valves 112, 114, air provided within lines 112, 114 can be delivered to the purge tank. This will allow only a minimal amount of viscous material to be purged prior to opening up the path to the dispensing pump 14. Each supply container 54 may be purged independently with respect to one another. In the shown embodiment, viscous material is delivered by line 92 directly to the housing 76 of the dispensing head 14.

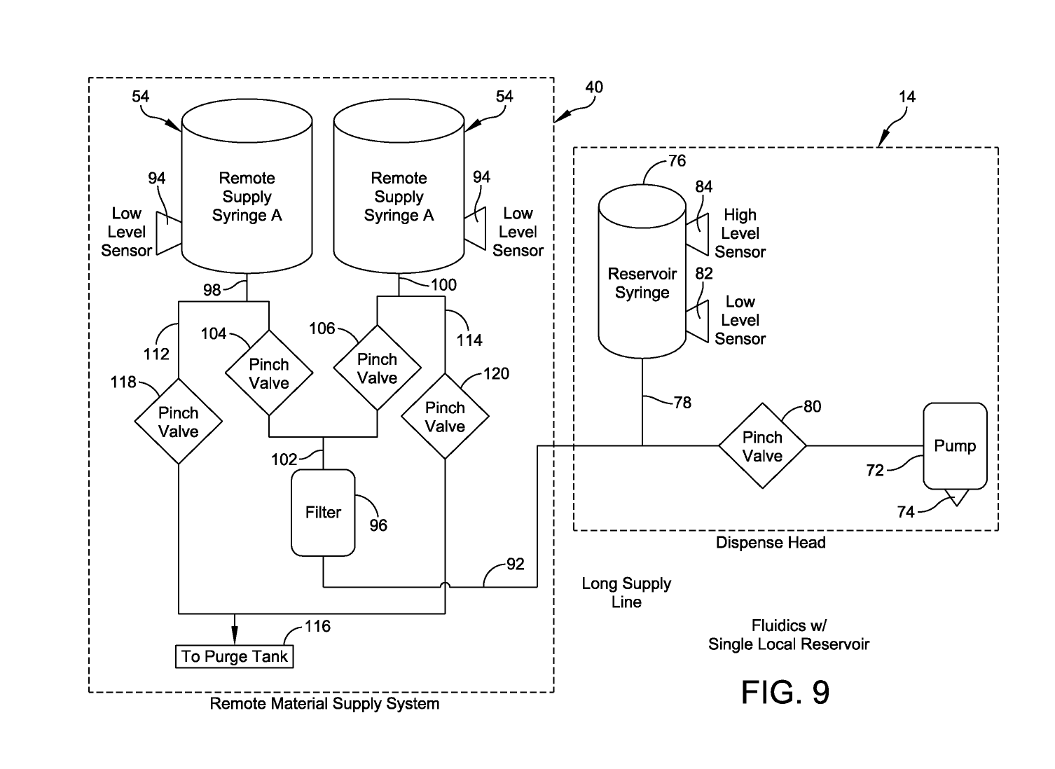

FIG. 9 illustrates an embodiment similar to the embodiment shown in FIG. 8, with the dispensing head 14 having a single local supply cartridge 76.

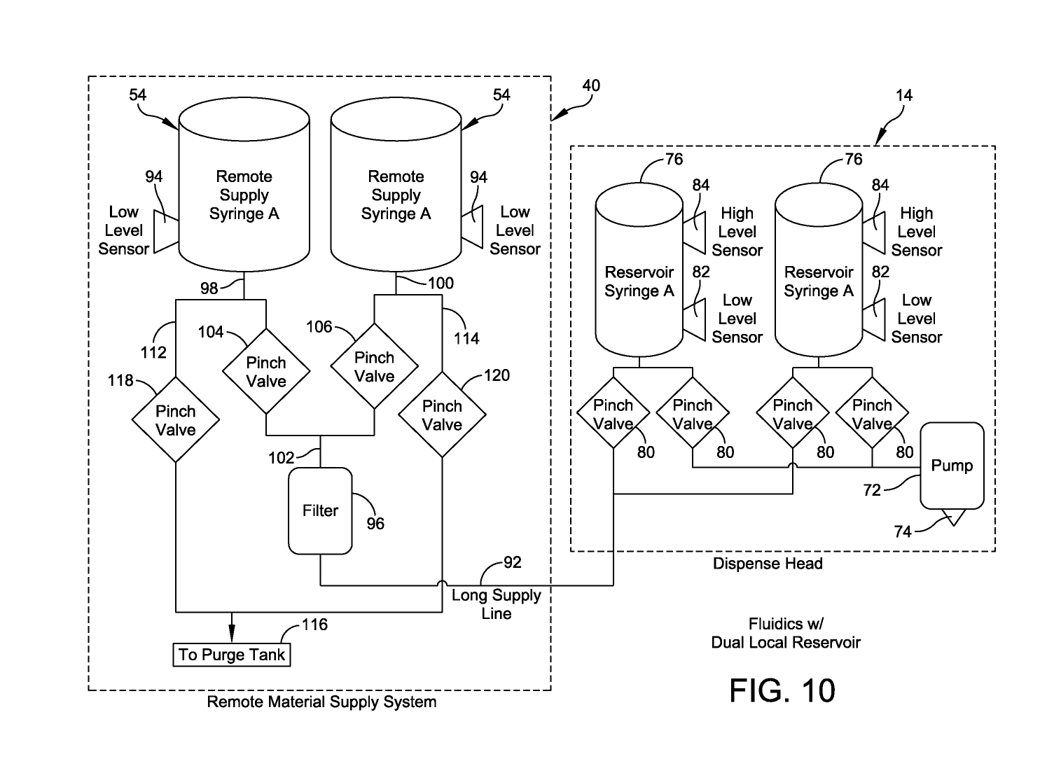

FIG. 10 illustrates an embodiment similar to the embodiment shown in FIG. 9, with the dispensing head 14 having two local supply cartridges 76. As shown, four valves 80 are provided to control the delivery of viscous material to the housing 76 of the dispensing head 14. The purpose of this embodiment is to allow constant use of the dispensing head. Since refilling the system takes at least ten seconds, if the dispensing head does not have ten seconds of down time, then a system having two cartridges and a valve controlling the feed from the cartridges can reduce the time needed to transition between the two cartridges to about two seconds. Another variation is that the dispensing pump air pressure can come from a plunger over the material or from a pocket of air or gas over the material. The air pressure over the material provides the best pressure control, but the plunger approach prevents the air from ever contacting the material—which can cause early curing of the viscous material.

During operation, the supply containers 54 of the external bulk supply system 40 fill the local supply cartridge(s) 76, which are turned off from pumping when being filled. Once the local supply cartridge(s) 76 are filled, the local supply cartridge(s) are turned off from communication to the external bulk supply system 40 by one or more valves. After being filled, the valve 80 associated with the local supply cartridge(s) 76 are opened to connect to the dispensing head(s) 72.

Having thus described at least one embodiment of the disclosure, various alternations, modifications and improvements will readily occur to those skilled in the art. Such alterations, modifications and improvements are intended to be within the scope and spirit of the disclosure. Accordingly, the foregoing description is by way of example only and is not intended to be limiting. The limit is defined only in the following claims and equivalents thereto.

What is claimed is:

1. A dispenser for dispensing viscous material on a substrate, the dispenser comprising:
a frame;
a substrate support assembly coupled to the frame and configured to support the substrate in a dispense position to dispense material on the substrate;
a gantry system coupled to the frame, the gantry system being configured to move a dispensing pump in x-axis, y-axis, and z-axis directions;
a dispensing pump coupled to the gantry system, the dispensing pump including a local supply reservoir, a dispensing nozzle, a first line to provide fluid communication between the local supply reservoir and the dispensing nozzle; and
a remote bulk feed system coupled to the local supply reservoir of the dispensing pump, the bulk feed system including a first remote supply container configured to contain viscous material, a second line to provide fluid communication between the remote bulk feed system and the local supply reservoir, and a first valve disposed in the second line and operable to deliver viscous material to and to cut off viscous material from the remote supply container.

2. The dispenser of claim 1, wherein the bulk feed system further includes a second valve disposed in the first line and operable to deliver viscous material to and to cut off viscous material from the dispensing nozzle.

3. The dispenser of claim 2, wherein the bulk feed system further includes a second remote supply container, a third line to provide fluid communication between the second remote supply container and the second line, and a third valve disposed in the third line and operable to deliver viscous material to and to cut off viscous material from the second line.

4. The dispenser of claim 2, wherein the bulk feed system further includes a fourth valve disposed in the fourth line that intersects the second line between the remote supply container and the first valve, the fourth valve being configured to purge air from the viscous material.

5. The dispenser of claim 1, wherein the bulk feed system further includes a bubble sensor disposed in the second line between the first valve and the local supply reservoir.

6. The dispenser of claim 5, wherein the bubble sensor detects air in material processed by a filter.

7. The dispenser of claim 1, wherein the bulk feed system further includes a low level sensor to detect a level of viscous material within the remote supply container below a predetermined amount.

8. The dispenser of claim 1, wherein the local supply reservoir of the dispensing pump includes a low level sensor and a high level sensor.

9. The dispenser of claim 1, wherein the dispensing pump further includes a second local supply reservoir and a third line to provide fluid communication between the second local supply reservoir and the dispensing nozzle.

10. A method of dispensing viscous material onto a substrate with a dispenser, the method comprising:
selectively dispensing viscous material from a dispensing nozzle of a dispensing head of the dispenser; and
controlling a flow of viscous material from a remote bulk feed system to a local supply reservoir of the dispensing head configured to contain viscous material, the bulk feed system including a first remote supply container configured to contain viscous material and a first line to provide fluid communication between the first remote supply container and the local supply reservoir.

11. The method of claim 10, wherein controlling the flow of viscous material includes operating a first valve in the first line to deliver viscous material to and to cut off viscous material from the local supply reservoir, the flow of viscous material from the first remote supply container of the bulk feed system to the local supply reservoir of the dispensing head being achieved when the dispensing head is not being used.

12. The method of claim 11, wherein the remote bulk feed system further includes a second remote supply container, and wherein the method further comprises controlling a flow of viscous material from the second remote supply container to the local supply reservoir with a second valve disposed between the second remote supply container and the local supply reservoir.

13. The method of claim 12, wherein the first valve and the second valve are pinch valves.

14. The method of claim 10, further comprising sensing gas bubbles in the first line after the first valve with a bubble sensor.

15. The method of claim 14, further comprising purging the first line when gas bubbles are sensed in the first line by the bubble sensor.

16. The method of claim 10, further comprising sensing a level of viscous material in the first remote supply container of the bulk feed system below a predetermined amount with a low level sensor coupled to the first remote supply container.

17. The method of claim 10, further comprising sensing a level of viscous material in the local supply reservoir below a predetermined amount with a lower level sensor coupled to the local supply reservoir.

18. The method of claim 17, further comprising sensing a level of viscous material in the local supply reservoir above a predetermined amount with a high level sensor coupled to the local supply reservoir.

19. The method of claim 10, further comprising pressurizing the viscous material within the first remote supply container of the bulk feed system.

20. The method of claim 10, wherein the remote bulk feed system further includes a second remote supply container in fluid communication with the first line by a second line, and wherein the method further comprises automatically purging the second line after switching the first remote supply container with the second remote supply container.
